(19) United States
(12) Patent Application Publication
(10) Pub. No.: US 2025/0216013 A1
(43) Pub. Date: Jul. 3, 2025

(54) Two-Sided Adaptor

(71) Applicant: Cooper-Standard Automotive Inc., Northville, MI (US)

(72) Inventors: Scott R. Schavey, Brighton, MI (US); Dustin Lowe, Howell, MI (US)

(73) Assignee: Cooper-Standard Automotive Inc., Northville, MI (US)

(21) Appl. No.: 18/582,458

(22) Filed: Feb. 20, 2024

Related U.S. Application Data
(60) Provisional application No. 63/616,549, filed on Dec. 30, 2023.

(51) Int. Cl. F16L 37/12; C08L 77/06

(52) U.S. Cl. CPC F16L 37/123; C08L 77/06; F16L 37/1235; C08L 2203/30; C08L 2207/04

(57) ABSTRACT

Disclosed herein is an adaptor having a body having a first end and a second end opposed to the first end, the first end and the second end are made from dissimilar materials, the first end has an outer surface supporting a concentric barb for connecting to a tubing, and the second end has a receptacle for connecting to a fitting.

### CROSS-REFERENCE TO RELATED APPLICATIONS

This application claims the benefit of provisional application Ser. No. 63/616,549 filed on Dec. 30, 2023, which is incorporated in its entirety herein by reference and made a part hereof.

### FIELD

The present disclosure relates generally to adaptors for connecting a first tubing to a second tubing in fluid systems in vehicles and more particularly an adaptor made from two dissimilar materials, one rigid and one flexible.

### BACKGROUND

Metal tubing is commonly used in vehicles such as automobiles, trucks, construction and excavation machines, and others to convey fluids needed to operate, for example, an engine, a cooling system, a battery, and power equipment associated with the vehicle. Such tubing is typically terminated in a barbed surface for connecting to other tubing. It is desirable to be able to modify existing metal tubing fluid conveyance systems with plastic tubing to repair or modify tubing pathways. Thus, an adaptor is needed to connect metal tubing with plastic tubing to establish fluid communication between the tubes.

### SUMMARY

Disclosed herein is an adaptor having a body having a first end and a second end opposed to the first end, the first end and the second end are made from dissimilar materials, the first end has an outer surface supporting a concentric barb for connecting to a tubing, and the second end has a receptacle for connecting to a fitting.

Also disclosed herein is a method for connecting a first tubing to a second tubing including the steps of: (1) providing a body having a first end and a second end opposed to the first end, the first end and the second end are made from dissimilar materials, the first end has an outer surface supporting a concentric barb for connecting to the first tubing, and the second end has a receptacle for connecting to the second tubing; (2) inserting the first end into a lumen of the first tubing; and, (3) attaching the receptacle to a portion of an outer surface of the second tubing to establish a fluid flow connection between the first tubing and the second tubing.

Also disclosed herein is a method for making an adaptor including the steps of: (1) providing a substrate of a first material, the substrate having a first end and a second end, the first end has an annular flange and the second end has an outer surface supporting a concentric barb; (2) providing a first mold; (3) positioning the substrate adjacent to the first mold with a portion of the first end positioned inside the first mold; (4) injecting a molten second material different from the first material into the first mold to form a body having a third end and an opposed fourth end, the third end has a receptacle and the fourth end has an annular chamber, and, (5) ejecting the adaptor from the first mold.

Other features and advantages of the invention will be apparent from the following specification taken in conjunction with the following Figures.

### BRIEF DESCRIPTION OF THE DRAWINGS

To understand the present invention, it will now be described by way of example, with reference to the accompanying drawings in which:

FIG. 1 is a perspective view of a tubing adaptor.

FIG. 2 is a vertical cross-sectional view of FIG. 1.

FIG. 3 is a perspective view of an assembly of the adaptor of FIG. 1 and a first tubing and a second tubing.

FIG. 4 is a cross-sectional view along lines C-C of FIG. 3.

FIG. 5 is a perspective view of a first part of the adaptor of FIG. 1.

FIG. 6 is a perspective view of a second part of the adaptor of FIG. 1.

FIG. 7 is a perspective view in partial cross section of the adaptor and tubing assembly with a portion of the first part of the adaptor removed for clarity.

FIG. 8a is a perspective view of a fluid flow assembly.

FIG. 8b is a horizontal cross-sectional view of the fluid flow assembly of FIG. 8a.

### DETAILED DESCRIPTION

While this disclosure is susceptible of embodiments in many different forms, there is shown in the drawings and will herein be described in detail preferred embodiments of the invention with the understanding that the present disclosure is to be considered as an exemplification of the principles of the disclosure and is not intended to limit the broad aspect of the disclosure to the embodiments illustrated.

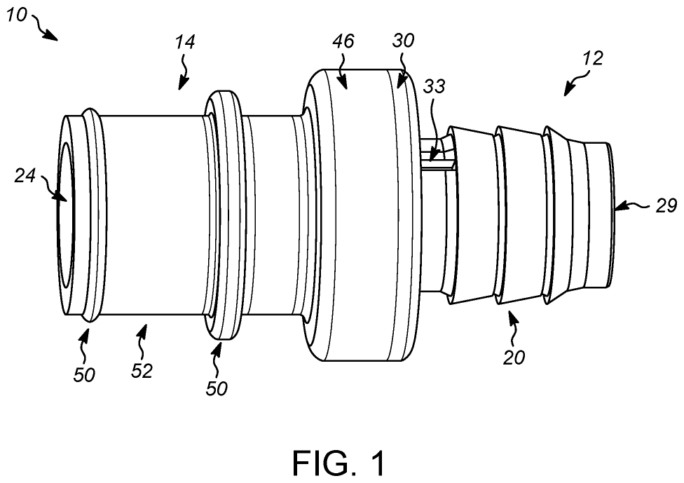

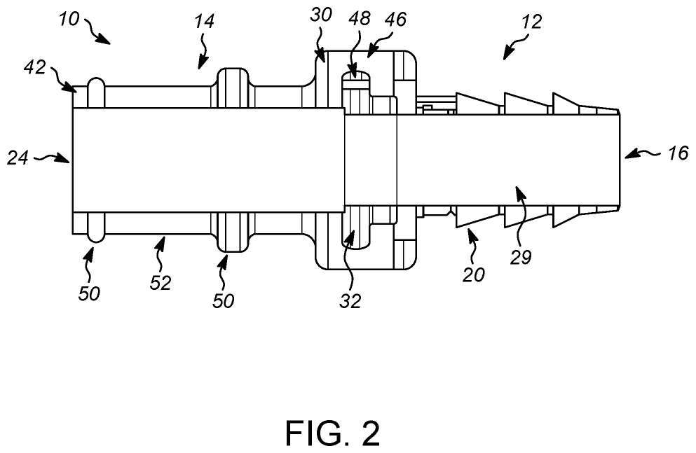

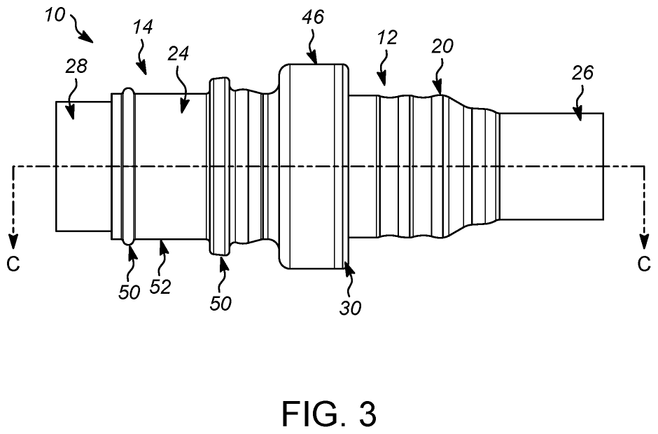

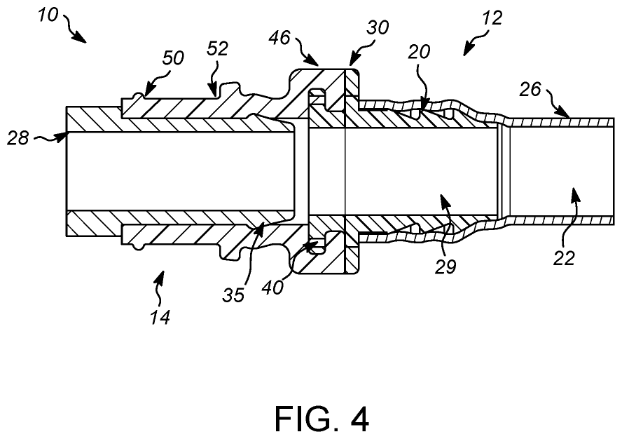

FIGS. 1-4 show an adaptor 10 having a first part 12 and a second part 14. The first part 12 and the second part 14 are preferably connected in a mechanical interlock, or a cohesive interlock, or, and most preferably, by both a mechanical interlock and a cohesive interlock. Preferably the first part 12 is made from a first material and the second part 14 is made from a second material dissimilar from the first material. Also, it is preferred for the first material to be more rigid than the second material. It is also preferred for the first material to be cohesive with the second material. The adaptor 10 is for connecting a first tubing 26 to a fitting such as a second tubing 28 as shown in FIGS. 3 and 4. The fitting 28 could be something other than a tubing such as a fitting on a pump or other component used under the hood of a vehicle. The connection establishes fluid communication through the adaptor 10 via a fluid pathway 29 therethrough to place the first tubing 26 in fluid communication with the second tubing 28.

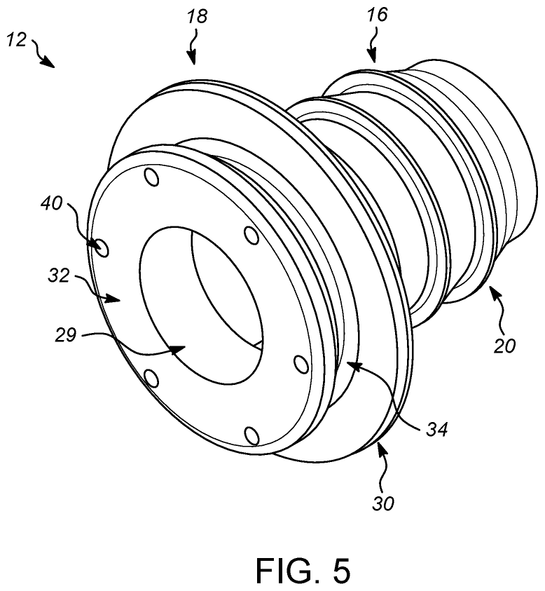

FIGS. 1, 2, and 5 show the first part 12. As shown in FIG. 5, the first part 12 has a first end 16 and a second end 18 opposed to the first end 16. The first end 16 supports three barbs 20 spaced from one another and disposed about a circumference of the first end 16 for connecting to an inner lumen 22 of the first tubing 26. While three barbs are shown, a different number of barbs could be used such as from 1 to 5 barbs, more preferably 2 to 4 barbs, and most preferably 3 barbs. In FIG. 1, a small rib 33 is shown behind the last retention barb and is slightly shorter than the last rib to avoid increasing the tube inner diameter and is perpendicular to the barb. The rib 33 provides rotational resistance to the tube on the barb (tube twist) by providing a feature that is perpendicular to the other features of the barb.

Turning back to FIG. 5, the barbed first end 16 can be inserted inside the lumen of a flexible elastomeric hose by hand, or fluidically, due to the elastomeric flexibility of the hosc. However, a machine may be required to insert the barbed end 16 inside the lumen of a semi-rigid plastic tube 28. In this case, the residual hoop stress of the semi-rigid plastic tube is high enough to ensure a reliable joint without the use of a hose clamp. Thus, a length of tubing can be attached to the barbed first end 16 of the adaptor in a factory setting to form a sub-assembly with the second part 14 of the adapter ready for use by an end user of the sub-assembly.

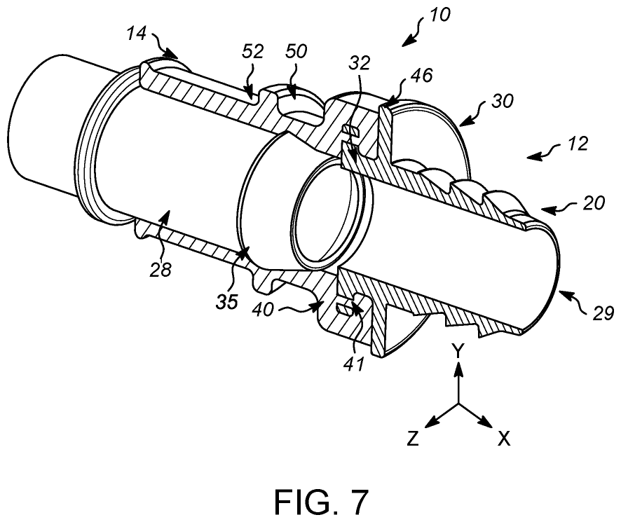

The second end 18 of the first part 12 has a first flange 30, a second flange 32, and a gap 34 therebetween. The first flange 30 has a first outer diameter dimensioned to be substantially equal to or greater than an inner diameter of the second part 14. The second flange 32 has a second outer diameter smaller than the first outer diameter. A plurality of through holes 40 may be circumferentially spaced on a face of the second flange 32. While six through holes 40 are shown any number of through holes 40 could be used from 1 to 20, more preferably from 4 to 15, and most preferably from 5 to 10 holes. The holes 40 as shown are circular with a smooth outline but could be of different shapes such as oval, polygonal, or irregular. The lines defining the holes can be smooth, scalloped, sinusoidal, or the like. When the first part 12 and the second part 14 are connected, the second material 41 is positioned in the through holes 40 to form a mechanical interlock between the first part 12 and second part 14 as is best seen in FIG. 7.

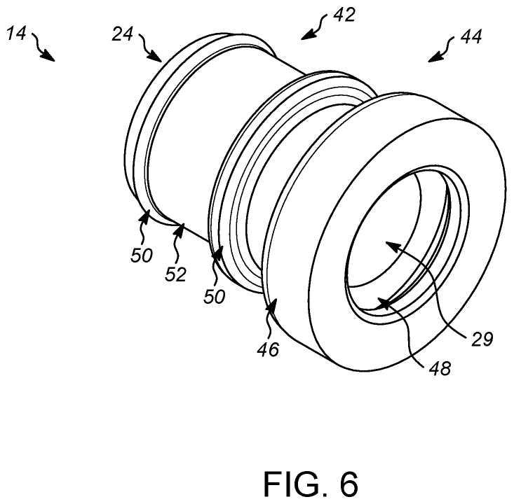

FIGS. 1, 2, and 6 show the second part 14. FIG. 6 shows the second part 14 having a third end 42 and a fourth end 44 opposed to the third end 42. The third end 42 supports the receptacle 24. Preferably, the receptacle 24 envelops a circumferential portion of an endform 35 on an end of the second tubing 28 as best seen in FIGS. 4 and 7. The fourth end 44 has an annular wall 46 defining an annular chamber 48 therein. The annular chamber 48 is dimensioned to receive the second flange 32 and the gap 34 of the first part 12. A pair of spaced annular ribs 50 are supported on the second part 14 defining a receiving surface 52 therebetween.

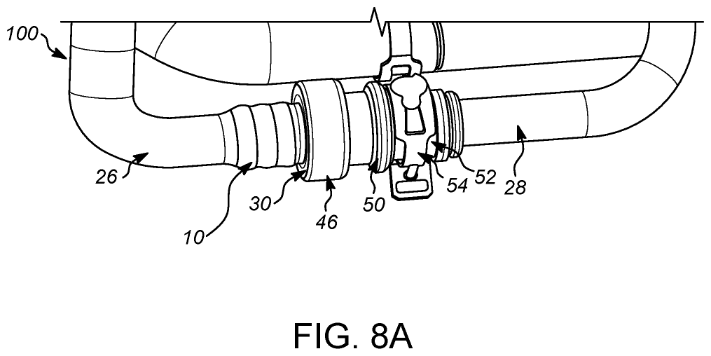

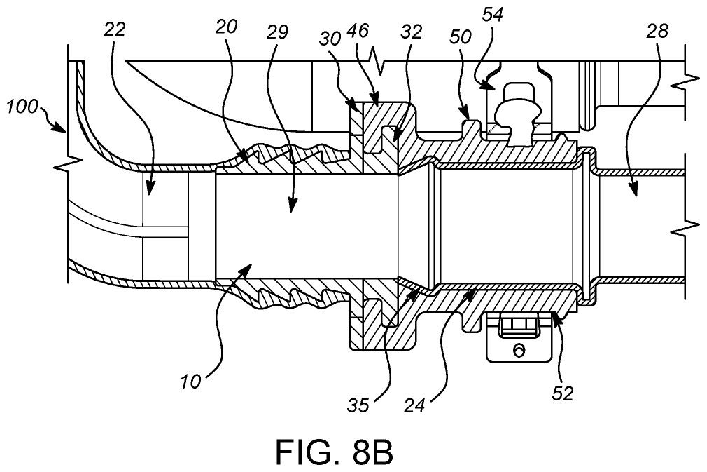

FIGS. 8a and 8b show a fluid flow assembly 100 having the adaptor 10, the first tubing 26 and the second tubing 28 in fluid flow communication. A hose clamp 54 is wrapped about the second part 14 in contact with the receiving surface 52. The annular ribs 50 prevent the hose clamp 54 from sliding along a length of the second part 14.

Turning to FIG. 7, the adaptor is manufactured in a two-shot molding process or an overmolding process. The two-shot process has two phases. The first phase produces a substrate from a rigid resin in an injection molding process. The substrate is the first part 12 of the adaptor 10. The substrate is allowed to cool and solidify. The substrate may be then transferred to a second mold chamber or another arrangement is envisioned in which a second material, different from the first, is injected into the second mold chamber to form the second part 14 bound to the substrate. The second material flows into the through holes 40 of the substrate to form a mechanical connection 41 between the substrate, first part 12 and the second part 14. The second material is allowed to cool before ejecting the final adaptor.

Overmolding is another multi-shot injection molding technique that may produce an adaptor made from two dissimilar materials. It also starts with the step of molding a substrate from a first material. The next step is placing the substrate into an overmold cavity within the same molding tool. The substrate may not be cooled. Once the substrate is in the cavity the molten second material is molded onto or around the substrate to form the adaptor. The second material flows into the through holes 40 of the substrate to form a mechanical connection 41 between the substrate, first part 12 and the second part 14.

The process of forming the adaptor 10 can include the optional steps of applying a primer to a portion of the adaptor or plasma treating a portion of the adaptor to ensure adhesion between the two dissimilar materials of each part 12 and 14.

The adaptor 10 can be used to provide or modify a fluid flow assembly 100 having the first tubing 26 of a plastic and a second tubing 28 equipped with the metal or a plastic endform 35 as shown in FIGS. 8a and 8b. The barbs 20 of the adaptor 10 are inserted into the lumen 22 of the first tubing 26 to form a tubing and adaptor assembly. Preferably, the connection between the first tubing and the adaptor is permanent. As best shown in FIG. 8b, the endform 35 on the end of the second tubing 28 is inserted into the receptacle 24 to releasably connect the second tubing 28 to the adaptor 10. A hose clamp 54, or other retention device, may be wrapped about the adaptor in contact with the receiving surface 52 to apply pressure to the adaptor to hold it in contact with the endform 35 of the second tubing 28. The connection of the first tubing 22 to the adaptor 10 and the second tubing 28 to the adaptor can be done in any order.

Two categories of tubing are used-one metal and the other plastic. Metal tubing is made from stainless steel or other metal and is commonly used in carrying fluid in automotive applications including coolant system fluid. The plastic tubing is semi-rigid and made from a polymeric material such as a polyolefin or a polyamide, for example. More preferably, the plastic tubing is made from polypropylene, talc-filled polypropylene, nylon 6,12 or glass filled nylon 6,12. One suitable tubing is sold by Cooper-Standard Automotive Inc. under the tradename PlastiCool® 2000.

Suitable materials to form the adaptor include rigid polymeric materials and flexible polymeric materials. Rigid polymers have a modulus of elasticity of greater than 100 MPa, and preferably from 1,000-10,000 MPa. Flexible polymers have a modulus of elasticity of less than 100 MPa, more preferably 5-20 MPa, and most preferably from 2-12 MPa.

Suitable rigid polymeric materials include polyamides, polyesters, polyolefins, cyclic olefin copolymers, polysulfones, polyphenyl sulfides (PPS), and polyvinyl chlorides.

Acceptable polyamides include aliphatic polyamides, semi-aromatic polyamides, and aromatic polyamides. Suitable aliphatic polyamides include those resulting from the condensation reaction of di-amines having a carbon number within a range of 2-13, aliphatic polyamides resulting from a condensation reaction of di-acids having a carbon number within a range of 2-13, polyamides resulting from the condensation reaction of dimer fatty acids, and amide containing copolymers. Thus, suitable aliphatic polyamides include, for example, nylon 6,6, and nylon 6,10. The polyamides can be glass filled as, for example, glass threads or glass beads, and in an amount by weight from 20% to 35%. Most preferably, the rigid polymer is nylon 6,6 filled with 33% by weight glass threads.

Suitable semi-aromatic polyamides include those derived from the reaction of aromatic acids with aliphatic diamines and are referred to as polyphthalamides or PPA. Suitable aromatic acids include terephthalic acid and isophthalic acid.

Suitable aromatic polyamides or aramids are obtained from the polycondensation of terephthalic acid with diamines. Suitable aramids include both para-aramids and meta-aramids. Suitable para-aramids include, for example, those sold under the tradenames KEVLAR, and TWARON. Suitable meta-aramids include, for example, TIJINCONEX, ARAWIN, NEW STAR, X-FIPER, NOMEX, and KERMEL.

Suitable polyesters include polycondensation products of di- or polycarboxylic acids and di- or poly hydroxy alcohols or alkylene oxides. Preferably, the polyesters are a condensation product of ethylene glycol and a saturated carboxylic acid such as ortho or isophthalic acids and adipic acid. More preferably the polyesters include polyethyleneterephthalates produced by condensation of ethylene glycol and terephthalic acid; polybutyleneterephthalates produced by a condensation of 1,4-butanediol and terephthalic acid; and polyethyleneterephthalate copolymers and polybutyleneterephthalate copolymers which have a third component of an acid component such as phthalic acid, isophthalic acid, sebacic acid, adipic acid, azelaic acid, glutaric acid, succinic acid, oxalic acid, etc.; and a diol component such as 1,4-cyclohexanedimethanol, diethyleneglycol, propyleneglycol, etc. and blended mixtures thereof.

Suitable polyolefins include homopolymers, copolymers and terpolymers obtained using, at least in part, monomers selected from α-olefins having from 2 to 12 carbons. Thus, suitable polyolefins include polyethylene, polypropylene, polybutene, polyhexene, and polyoctene, to name a few.

Suitable flexible polymeric materials include thermoplastic elastomers or thermosetting elastomers. Suitable thermoplastic elastomers include styrenic block copolymers, thermoplastic polyolefin elastomers, thermoplastic vulcanizates (TPV), thermoplastic urethanes, thermoplastic copolyesters, thermoplastic polyamides, and unclassified thermoplastic elastomers. Most preferably, the flexible polymer is a TPV sold under the tradename SANTOPRENE.

Suitable thermosetting elastomers include ethylene propylene diene monomer (EPDM), epichlorohydrin rubber, chloroprene, nitrile rubber, hydrogenated nitrile rubber, fluorinated rubber (FKM), polyacrylate rubber (ACM), ethylene acrylate rubber (AEM), styrene-butadiene-rubber (SBR), chloro-sulfonated monomer (CSM) rubber, and isoprene-isobutylene rubber.

Many modifications and variations of the present invention are possible in light of the above teachings. It is, therefore, to be understood within the scope of the appended claims the invention may be protected otherwise than as specifically described.

1. An adaptor comprising:
a body having a first end and a second end opposed to the first end, the first end and the second end are made from dissimilar materials, the first end has an outer surface supporting a concentric barb for connecting to a tubing, and the second end has a receptacle for connecting to a fitting.

2. The adaptor of claim 1 wherein the first end is dimensioned to connect to an internal lumen of the tubing.

3. The adaptor of claim 2 wherein the receptacle is dimensioned to circumscribe a portion of an outer surface of the second tubing.

4. The adaptor of claim 1 wherein the first end is made from a polymeric material having a modulus of elasticity greater than that of the second end.

5. The adaptor of claim 1 wherein the first end is made from a material selected from the group consisting of: polyamides, polyesters, polyolefins, cyclic olefin copolymers, polysulfones, polyphenyl sulfides, and polyvinyl chlorides.

6. The adaptor of claim 1 wherein the first end is made from an aliphatic polyamide, a semi-aromatic polyamide or an aromatic polyamide.

7. The adaptor of claim 1 wherein the first end is made from nylon 6,6.

8. The adaptor of claim 1 wherein the second end is made from a thermoplastic elastomer or a thermosetting elastomer.

9. The adaptor of claim 8 wherein the thermoplastic elastomer is selected from the group consisting of: styrenic block copolymers, thermoplastic polyolefin elastomers, thermoplastic vulcanizates, thermoplastic urethanes, thermoplastic copolyesters, thermoplastic polyamides, and unclassified thermoplastic elastomers.

10. The adaptor of claim 8 wherein the thermosetting elastomer is selected from the group consisting of: ethylene propylene diene monomer (EPDM), epichlorohydrin rubber, chloroprene, nitrile rubber, hydrogenated nitrile rubber, fluorinated rubber (FKM), polyacrylate rubber (ACM), ethylene acrylate rubber (AEM), styrene-butadiene-rubber (SBR), chloro-sulfonated monomer (CSM), and isoprene-isobutylene rubber.

11. A method for connecting a first tubing to a second tubing comprising the steps of:
providing a body having a first end and a second end opposed to the first end, the first end and the second end are made from dissimilar materials, the first end has an outer surface supporting a concentric barb for connecting to the first tubing, and the second end has a receptacle for connecting to the second tubing;
inserting the first end into a lumen of the first tubing; and,
attaching the receptacle to a portion of an outer surface of the second tubing to establish a fluid flow connection between the first tubing and the second tubing.

12. The method of claim 11 further comprising the step of mounting a hose clamp about the circumference of the second end.

13. The method of claim 9 wherein the second end is removably connected to the second tubing.

14. A method for making an adaptor comprising the steps of:
providing a substrate of a first material, the substrate having a first end and a second end, the first end has an annular flange and the second end has an outer surface supporting a concentric barb;
providing a first mold;
positioning the substrate adjacent to the first mold with a portion of the first end positioned inside the first mold;
injecting a molten second material different from the first material into the first mold to form a body having a third end and an opposed fourth end, the third end has a receptacle and the fourth end has an annular chamber; and,
ejecting the adaptor from the first mold.

15. The method of claim 14 wherein the step of providing the substrate comprises the steps of providing a second mold, injecting the first material in a molten state under pressure into the second mold, ejecting the substrate from the second mold and allowing the substrate to cool.

16. The method of claim 14 wherein the step of providing the substrate comprises the steps of providing a second mold, injecting the first material in a molten state under pressure into the second mold, and the step of positioning the substrate is performed while the substrate is hot.

17. The method of claim 14 wherein the annular flange has a plurality of through holes and the second material is positioned in the through holes.

18. The method of claim 14 further comprising the step of applying a primer to a portion of the substrate prior to injecting the second material into the first mold.

19. The method of claim 14 further comprising the step of exposing a portion of the substrate to a plasma surface treatment prior to injecting the second material into the first mold.

20. The method of claim 14 wherein the first material is more rigid than the second material.
